(19) United States
(12) Patent Application Publication
(10) Pub. No.: US 2012/0038925 A1
(43) Pub. Date: Feb. 16, 2012

(54) Method for examining liquids and apparatus therefor

(75) Inventors: Achim Gahr, Goldbach (DE); Manfred Jagiella, Nurtingen-Reudern (DE)

(73) Assignee: Endress + Hauser Conducta Gesellschaft fur Mess- und Regeltechnik mbH + Co. KG, Reinach (CH)

(21) Appl. No.: 13/265,554

(22) PCT Filed: Apr. 8, 2010
(86) PCT No.: PCT/EP2010/054652

§ 371 Date: Oct. 21, 2011

(30) Foreign Application Priority Data
Apr. 22, 2009 (DE) 10 2009 002 570.7
Jul. 31, 2009 (DE) 10 2009 028 171.1
Aug. 5, 2009 (DE) 10 2009 028 254.8

(51) Int. Cl. G01N 21/00

(52) U.S. Cl. 356/440

(57) ABSTRACT

A method and apparatus for determining a property of a medium, the apparatus including: a light source in a housing, for irradiating a space along a measuring path; a receiver in a housing, for registering intensity of light which has traversed the measuring path; wherein the measuring path enters through a first window section in a wall of the housing of the light source into the space, and wherein the measuring path leaves from the space through a second window section in a wall of the housing of the receiver. A medium to be measured is introducible in such a manner into the space, that the measuring path for a media measurement extends through the measured medium. At least one reference absorber, which is introducible at times into the space; and wherein the measuring path for at least one reference measurement extends through the reference absorber, when the reference absorber is brought into the space.

The invention relates to a method for determining the ingredients of a liquid medium utilizing a light source and an optical detector, for example, utilizing a spectrometer, or photometer, having at least one measuring beam and at least one reference beam, wherein at least one measuring beam is directed through the medium to be examined and at least one reference beam is directed outside the medium to be examined.

The photometrically measuring probes used for such method, for in-situ use or on-line use, for determining the ingredients of a fluid, for example river water or waste water, include, usually, a light source and an optical detector, for example, a spectrometer, having at least one measuring beam and at least one reference beam, wherein the light of the light source, in given cases, is dispersed and bundled by means of at least one optical lens to an essentially parallel beam.

Spectrometers with measuring, and reference, beams are known from DE 3 248 070 A1 and DE 3 340 570 A1 and, for “in situ” measuring, from AT-A 2167/99.

DE 3 248 070 A1 relates to an infrared analyzer with a beam, which is split and, on the one hand, directed through a measuring cuvette and, on the other hand, through a reference cuvette.

DE 3 340 570 A1 relates to a spectral photometer, wherein the beam likewise is split into a measuring beam and a reference beam, however, offset in time, by a rotary mirror. In such case a shared detector is provided for the two beams. In order to assure, that the two beam portions have equal wavelength, frequency shifting in the monochromator is only performed, when no measuring is being done.

Both apparatuses are discretely constructed, i.e. composed of a plurality of units, which, indeed, can have a shared housing, which, however, does not permit the apparatus, as a whole, to be immersed in the measuring fluid, but, instead makes it necessary to introduce drawn samples in corresponding containers such as cuvettes, or the like, into the apparatus.

AT-A 2167/99 relates to a spectral probe for “in situ” measuring. In the case of this probe, the measuring beam is directed through a light transmissive window into the fluid to be examined and through a further light transmissive window back into the probe. The reference beam is only directed in the interior of the probe, without passing through the window contacting the fluid.

The need for “in situ” measurement of water, especially river water, waste water and process water in pipelines, is rising.

With spectral photometry, characterizing parameters, such as e.g. nitrate and the SAC (spectral absorption coefficient) can be directly measured at variable wavelength. Other variables are color and turbidity.

Especially in combination with today's available mathematical evaluation methods, qualified measurements technology also permits measurement of sum parameters, such as e.g. TOC, i.e. total organic carbon, and the chemical oxygen demand, short COD, as indirectly measurable parameters. These are ascertained by integrating the absorption spectra over a predetermined wavelength range, especially in the spectral UV/Vis-region.

European Patent EP 1 472 521 B1 discloses a method, wherein a longitudinally movable piston or piston valve sucks the medium to be examined into, and removes the medium from, a measurement space and wherein the piston or piston valve, during its stroke movement, cleans windows in the optical beam path. The medium to be measured is sucked by means of the piston into a glass cylinder. The optical axis, composed of a light source, at least one optical lens, which bundles the light to an essentially parallel beam, at least one optical lens, which steers the light, after leaving the measured medium, to the entrance of a light conductor or to the inlet of a spectrometer or photodetector, is arranged transversely to the cylinder axis. The cylinder axis is e.g. vertical. The optical axis and the axis of the measuring cylinder are at e.g. an angle of 90° with respect to one another. In such case, at least one measuring beam is directed through the fluid to be examined and at least one reference beam offset in time through a piston or piston valve displacing the fluid. In such case, a light collecting optical system can be used, composed of at least one lens, which steers the beams onto the entrance of a light conductor or the entrance of the photodetector or spectrometer, wherein the piston displacing the fluid can serve as beam aperture, which passes a part of the light beams and blocks the rest.

The reference path extends, according to the teaching of the above patent, through a bore, which thus essentially contains air. In this way a reference point is given. However, insofar as the changing variables of an optical measuring arrangement can have, on the one hand, a number of degrees of freedom, and, on the other hand, this is a reference taken in air may be lying widely from the reigning media properties, there is a need for improving the accuracy of measurement, particularly for measurements over long periods of time.

According to the invention, method and apparatus are provided, which enable capture of a more exact, measured value.

The method of the invention includes:

Irradiating a space with light along a measuring path between a light source and a light receiver, wherein the light enters into a space through a first window section and leaves the space through a second window section; registering the intensity of light, after it has left the space, by means of the receiver and ascertaining absorption along the measuring path, wherein the space between the first window section and the second window section in a media measurement contains a medium to be measured, through which the light passes, wherein, in at least a first reference measurement, a first reference absorber, which has a defined absorption and through which the light passes, is arranged in the space between the first window section and the second window section, and determining properties of the measured medium on the basis of the absorption during the media measurement, taking into consideration the absorption during the at least one reference measurement.

In a further development of the invention, there is at least a second reference measurement, in which a second reference absorber of defined absorption is arranged in the space between the first window section and the second window section.

In a further development, the absorption during the second reference measurement differs from the absorption during the first reference measurement.

Additionally, the invention can include the option of a third reference measurement and, in given cases, further reference measurements.

If only one reference measurement is performed, this can serve for performing a one point calibration, with which the zero-point of a calibration function, especially a calibration curve, can be ascertained. If two reference measurements are performed, a two point calibration can be performed, in which the zero-point and a slope or a gradient of a calibration function, especially a calibration curve or a linear function, can be ascertained. If three or more reference measurements are performed, a calibration function, especially a calibration curve or a non-linear calibration function, can be ascertained with still higher accuracy.

In a further development of the method, the one or more reference absorbers are integrated in a piston or piston valve, with which the measured medium is sucked into a measuring cylinder forming the space, through which the light passes along the measuring path.

Preferably used as reference absorbers are solid bodies, especially glasses, e.g. glasses of high purity with different transmission characteristics, especially quartz glasses, such as e.g. Suprasil, Homosil, Herasil or Infrasil. In order to achieve different transmission characteristics, the thickness of the solid bodies passed through by the measuring radiation, or the surface characteristics of the solid bodies, can be modified. Another opportunity for adjusting certain transmission characteristics is to dope the glasses, e.g. with heavy metals.

Preferably used as reference absorbers are solid bodies, whose absorption remains constant over a plurality of measurements, also under the influence of UV measuring radiation. An example of this is Suprasil quartz glass. Such reference absorbers are especially suitable, in order to compensate for drift of the optical apparatus, for example, due to power fluctuations of the light source or the light receiver, due to fouling, clouding or scratching of the window sections through which the measurement beam passes. These influences lead, as a rule, to a lessening of the absorption measured by the receiver, which is superimposed on the absorption of the measured medium in a media measurement.

In regular intervals, especially before each media measurement, one reference measurement or a number of reference measurements can be performed, wherein the piston or piston valve is shifted in such a manner, that one reference absorber is brought into the measuring path, or a number of reference absorbers are brought one after the other into the measuring path. On the basis of the so ascertained reference spectra, compensation values can be calculated and stored, with which aging related, or application related, drift of the optical apparatus can be compensated. This calibrating, or adjusting, on the basis of reference measurements with the “internal” reference absorbers of the apparatus is also referred to as internal calibrating, or internal adjusting.

In particular, the data of the reference measurements can be used also for sensor diagnostics and/or for predictive diagnostics and maintenance.

The data of the reference measurements can, for example, be registered long term and statistically evaluated, for example, in order to establish maintenance points in time, especially cleaning points in time, and/or to identify changes in the measuring path in the case of reference measurements, to, for example, indicate aging of the light source or fouling, clouding or scratching of the window sections through which the measurement beam passes.

Thus, for example, the development of the stored compensation values in time can be evaluated and monitored. For example, a warning signal can be output, when the compensation values exceed a predetermined threshold value. The threshold value can be so predetermined, that, after the exceeding of the threshold value, still a time buffer of some hours or days remains, within which the media measurements still deliver reliable measurement results. The warning signal can display this time buffer. A service person can then perform a calibrating or adjusting and/or the required maintenance measures, such as cleaning the apparatus, replacement of the light source, or replacement of the window sections through which the measurement beam passes, within the time buffer schedule.

It is also possible to extrapolate the curve for compensation values as a function of time, and so to predict, when the exceeding of a predetermined threshold value will arise. Therewith, in advance, a maintenance point in time can be predicted and output.

Fouling of or damage to the window sections through which the measurement beam passes can be recognized by performing an additional reference measurement in air as a reference absorber. For this, the piston or piston valve can, for example, have an air filled bore, which can be brought into the measuring path for the purpose of a reference measurement in air.

In longer time intervals, i.e. in each case after a series of media measurements, an external calibrating, or adjusting, can be performed by recording a supplemental reference spectrum in a reference liquid of known concentration. The obtained reference spectrum can be compared with reference spectra recorded in the context of the internal calibrating, or adjusting, done with the reference measurements with the reference absorbers. Deviations between the reference spectrum of the reference liquid and the reference spectra of the reference absorber are, in this way, ascertained and stored. The time curves of these deviations can be evaluated. For example, a warning signal can be output, when deviations exceed a predetermined threshold value, or after an extrapolation method predicts, when an exceeding of the threshold value is to be expected.

With the help of a real time clock, an internal logbook can be created, in which, for example, points in time and type of the performed reference measurements, deviations, and arisen problems are registered and stored.

The apparatus of the invention comprises A light source in a housing, for irradiating a space along a measuring path; a receiver in a housing, for registering intensity of light which has traversed the measuring path; wherein the measuring path enters into the space through a first window section in a wall of the housing of the light source, and wherein the measuring path leaves from the space through a second window section in a wall of the housing of the receiver; wherein a medium to be measured is introducible into the space in such a manner, that the measuring path for a media measurement extends through the medium; and at least one reference absorber, which is introducible at times into the space, wherein the measuring path for at least one reference measurement extends through the reference absorber, when the reference absorber has been introduced into the space.

In a further development of the invention, the apparatus includes, or has associated therewith, a control and evaluation circuit, which is suitable for ascertaining, on the basis of the ascertained intensity of light in the case of a media measurement and taking into consideration the at least one reference measurement, the absorption characteristics of the measured medium located in the measuring path.

In a further development of the invention, the apparatus includes at least a second and, in given cases, a third, reference absorber.

In a further development of the invention, a reference absorber can comprise a solid body, for example, a glass body with a definedly coated surface, for example, a metal vapor deposited surface, for example, a Cr—Ni-layer.

In a further development of the invention, a reference absorber can comprise a solid body which is colored within its volume, for example, a colored glass body, for which, for example, halogenides are suited as dyes.

Other suitable dyes for obtaining a defined absorption are transition metal complexes of the transition metal elements or organic polycyclics. Additionally, also diffusion disks can be applied or clean glasses with different transmission characteristics, e.g. Suprasil, Homosil, Herasil, Infrasil, HOQ310, UVBK7, also: UBK-7, etc.

In a further development of the invention, a reference absorber includes an absorption definedly changing as a function of a coordinate. This can be achieved, for example, by a metal coating, whose thickness is variable in one direction, for example, the movement direction, in which the reference absorber is brought into the measuring path. In the case of a piston in a cylinder, the absorption of the reference absorber can vary, for example, with the axial position z of the absorber. In this way, with a pumping stroke of the piston, an absorption profile can be recorded. The layer thickness d or the absorber density a of the absorption layer can, in such case, vary, for example, linearly or logarithmically with the coordinate of variation.

In the first case, there is an exponential relationship between the variable position of the piston and the measured intensity, in the second case a linear relationship.

In the case of a reference absorber with an absorber body rotatable around the cylinder axis, the absorption thickness d can also vary as a function of the angle of rotation φ, wherein, for this, preferably, the following holds: d(φ)=d(φ+180°).

In a further development of the invention, a reference absorber can comprise a transparent container, which contains a reference medium of defined absorption, for example, a reference liquid. The reference medium can be sealed in the container, for example, by means of a glass melted closure, or the container can be filled and emptied via supply and drain lines, in order, in given cases, to be able to introduce different reference liquids with different defined absorption characteristics into a container. Suitable as reference liquids are, for example, solutions of potassium hydrogen phthalate (PHP) in different PHP-concentrations.

The glass material of the reference absorber can comprise, especially, quartz glass.

One or a number of the named reference absorbers can, for example, be integrated in a piston, with which the measured medium is sucked into a measuring cylinder forming the space, through which the light passes, along the measuring path.

In this embodiment of the invention, the light source and the receiver are arranged in the same housing, wherein the wall of the housing having the window sections comprises the wall of the measuring cylinder. The measuring cylinder can even be manufactured of glass, and, thus, form the window sections, or it can, for example, comprise a metal, especially stainless steel, in which case the window sections can then be flushly mounted into the lateral surfaces of the measuring cylinder.

Advantageously, the cylinder is manufactured completely of suitable glass, since, in such case, transitions between glass and other materials, which can lead to problems, are avoided.

To the extent that UV-light sources are to be used, the window sections, or the complete measuring cylinder, are/is provided in the form of UV-transparent and UV-resistant material, especially quartz glass.

The piston can have sealing elements, whose sealing lips serve at the same time as wipers, this meaning thus that the piston or piston valve, in its stroke movement, cleans the window sections in the measuring path. The measured medium is sucked by means of the piston into a measuring cylinder. The measuring path can have collecting lenses, in order to cause the light to pass as parallel rays through the space, and then to focus the light toward the receiver.

The measuring path passes into the space preferably perpendicularly to the piston axis.

The receiver can comprise a spectrometer or a simple photodetector.

For example, when the lower edge of the piston reaches the upper edge of the measuring path, a media measurement can be performed.

For reference measurements, the piston is so shifted, that the relevant reference path is introduced into the measuring path.

In a further development of the invention, the measuring cylinder comprises a cleaning section with an inlet opening and an outlet opening in the lateral surface, and the piston has an upper seal and a lower seal, whose separation has a larger axial extent than the axial distance between the inlet opening and the outlet opening. When the piston is moved into a position, such that the two openings are enclosed between the seals, then the annular gap between the cylinder wall and the piston lateral surface can be rinsed, in order to clean the surfaces of the reference absorber.

In a further development of the invention, the inlet opening and the outlet opening are axially so positioned, that the cleaning section axially overlaps with the measuring path, wherein especially the reference absorber with the weakest absorption is positioned in the measuring path, when the piston is positioned for cleaning the absorber surfaces. In this way, the cleaning progress can be monitored during the cleaning.

In special cases of application, it can be advantageous, before the cleaning, to take a spectrum of the fouled reference absorber, and to evaluate this spectrum in comparison with the spectrum of the cleaned reference absorber as reference. In this way, information concerning degree and the type of the fouling and, in given cases, therein accumulated substances can be found.

The piston can be moved, hydraulically or pneumatically, by means of a drive, for example, by means of a stepper motor, wherein position sensors can be provided, in order to be able to assure the right position of the piston, or of the reference absorber. To the extent that a rotation of the piston is required, a corresponding drive is likewise provided for that purpose.

The control, and evaluating, unit controls preferably all components of the apparatus and reads their data out.

The evaluation unit can especially be provided not only to register and statistically evaluate, long term, the data of the media measurements, but, also the data of the reference measurements, for example, for establishing cleaning points in time, and to identify changes in the measuring path in the case of reference measurements, indicating, for example, aging of the light source.

The light source can be selected, depending on field of use, from continuous light sources or flash lamps operating in the range between the mid-infrared region and the ultraviolet. The receiver is to be selected correspondingly.

The receiver can comprise a spectrometer or a broadband receiver, with the latter registering only a total intensity. Suitable as spectrometers are basically interferometers and dispersing arrangements involving prisms, gratings and the like.

The invention will now be explained on the basis of the examples of embodiments illustrated in the drawing, the figures of which show as follows:

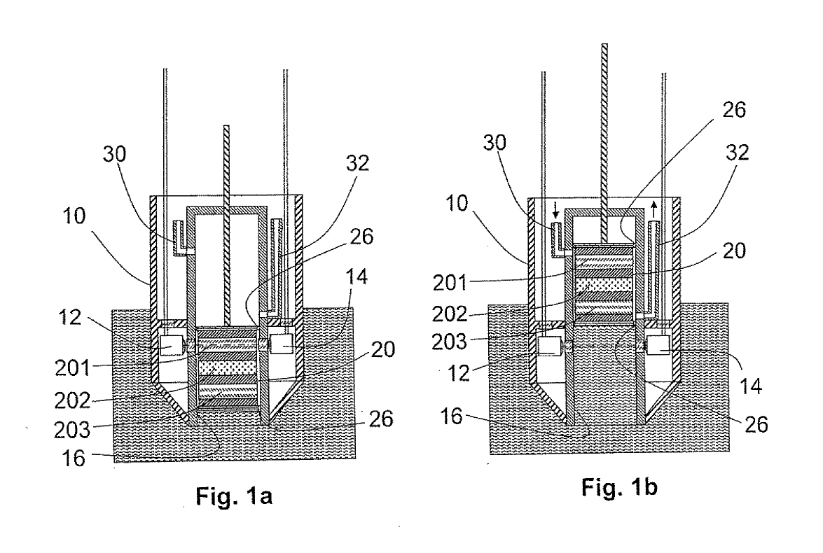

FIG. 1a a longitudinal section through an example of an embodiment of a measuring device of the invention in the operating state of a reference measurement;

FIG. 1b a longitudinal section through the example of an embodiment in FIG. 1a in the operating state of a media measurement;

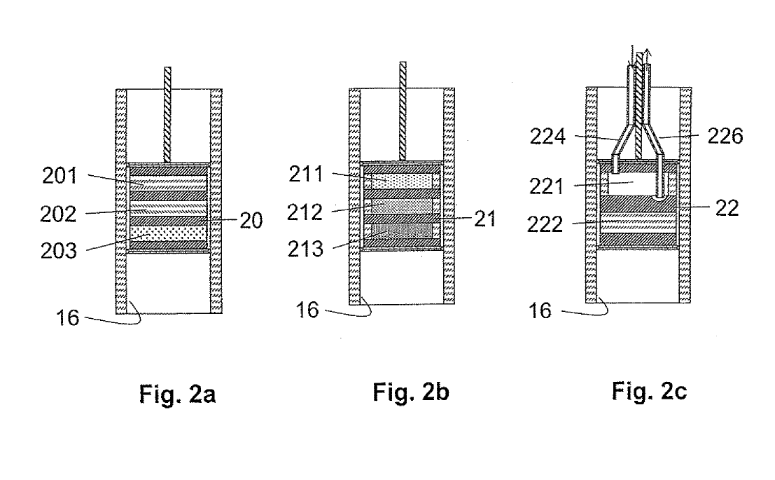

FIG. 2a a longitudinal section through a first example of an embodiment of a piston with reference absorbers;

FIG. 2b a longitudinal section through a second example of an embodiment of a piston with reference absorbers; and

FIG. 2c a longitudinal section through a third example of an embodiment of a piston with reference absorbers;

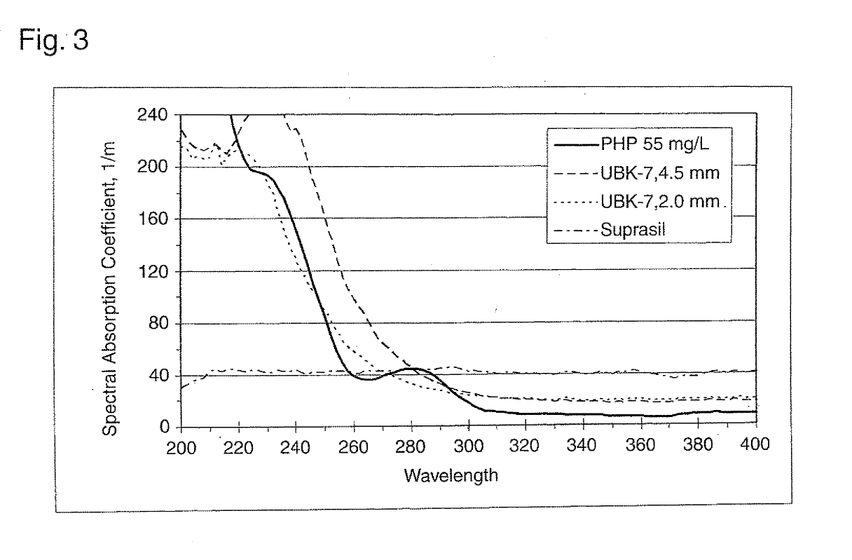

FIG. 3 absorption spectra of various solid, reference absorbers in comparison with an absorption spectrum of a classic reference liquid;

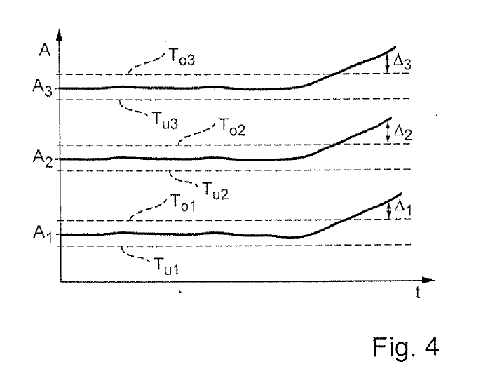

FIG. 4 a diagram of reference values as a function of time for reference measurements ascertained with three reference absorbers of Suprasil;

FIG. 1a shows a longitudinal section through the probe head of a measuring device of the invention, comprising, in a housing 10, a light source 12 and a receiver 14.

The light source 12 comprises a flash lamp, which covers a spectral range between about 200 nm and 700 nm. The receiver comprises a spectrometer with a grating as dispersing element, which directs the received light wavelength dependently onto a photodiode row or a photodiode array.

For implementing a spectrometer, the receiver 14 of the probe head can have a ferrule, which holds light conductors in position for guiding the received light to the spectrometer (not shown).

The light of the light source irradiates a measuring cylinder 16, which here is executed as a stainless steel cylinder with flush mounting quartz glass windows. Alternatively, the entire measuring cylinder can be of quartz glass.

A piston 20 is provided to suck medium to be measured into the measuring cylinder. FIG. 1a shows the piston in a lower position, in which a reference absorber 201, which is integrated in the piston, is positioned in the measuring path, which extends from the light source 12 to the receiver 14. The reference absorber comprises a quartz glass body, whose surfaces in the measuring path have a Ni—Cr layer, in order that the light in the case of passage through the reference absorber 201 is weakened in defined manner. Piston contains a second reference absorber 202 and a third reference absorber 203, which likewise have Ni—Cr layers, but of other coating thicknesses, and which are arranged in other axial positions of the piston.

The coating thicknesses and materials are, for example, so selected, that the absorptions of the reference absorbers are distributed over the measuring range of the measuring device, in order to enable an encompassing calibrating of zero-point and slope and, in given cases, arising non-linearities. The strongest absorption of a reference absorber can, for example, effect a weakening to 1% of the output intensity.

By shifting of the piston 20, the reference absorbers 201, 202, 203 are, when calibration is needed, positioned in the measuring path for reference measurements.

In a further development of the invention, the absorptions of the reference absorber can correspond to limit values between different fouling classes. This can, for example, be advantageous, when waste water fees increase as a function of fouling class. In this case, the reference absorber can not only serve for creation of a calibration function but, also, at the same time as a comparison standard for associating a medium with a fouling class.

Piston 20 is equipped with sealing, and cleaning, lips 26, which, on the one hand, are suitable for sealing the interface of the piston 21 against the wall of the measuring cylinder 16, in order to enable sucking and ejecting of the measured medium, and which, on the other hand, are provided to clean the window sections of the measuring path during the shifting of the piston.

FIG. 1b shows the measuring device with the piston in an upper position, in the case of which measured medium has been sucked into the measuring path, in order to perform a media measurement. At the same time, this position enables a cleaning of the surfaces of the reference absorbers, since, through a supply line 30 and a drain 32, which communicate with an annular gap between the piston 20 and the wall of the measuring cylinder 16, cleaning liquids and, in given cases, drying gasses can flow past, onto the surfaces of the reference absorbers.

In a supplementation (not shown), the wall of the measuring cylinder 16 can have a surrounding cleaning lip, where the piston can be moved past, in order to wipe off the surfaces of the reference absorbers. The cleaning lip can, for example, comprise a ring of an elastomer, which is arranged in a groove in the measuring cylinder wall. In a further development, the ring can be tubularly embodied and connected to a pressure line, in order to be able to control, with a pressure supply, the inner radius, or the pressing pressure, of the cleaning lip.

FIGS. 2a, 2b and 2c show longitudinal sections through different examples of embodiments of reference absorbers integrated in pistons arranged in measuring cylinders 16 of quartz glass.

The reference absorbers 201, 202, 203 in FIG. 2a comprise in each case a quartz glass cylinder, whose lateral surface has been vapor deposited with Cr—Ni layers of different thicknesses, so that, for example, intensity decrease, or transmission loss, can be selected at 1/e, (1/e)̂2.5 and (1/e)̂4.

The reference absorbers 211, 212, 213 in FIG. 2b comprise, in each case, a cuvette with a cylindrical outer wall of quartz glass containing sealedly and long term stablely, for example, via glass melted closure, especially, a liquid reference medium. The reference media can comprise, for example, contain, measuring-point-specific materials in defined concentrations, for example, PHP, phenols, or other aromatics. The cuvettes are integrated into a piston 21.

The reference absorbers 221, 222 in FIG. 2c include, on the one hand, a reference cuvette 221, which is fillable via a supply line 224 with a reference medium, which, after transpired reference measurement, is removed via a suction line 226, or which can be replaced with a cleaning solution or another reference medium. This arrangement enables, for example, a simple matching to the requirements of specific measuring points, in that reference media of defined concentration are provided in supply containers, from which the reference media can be pumped selectively into the reference cuvette.

Additionally to reference cuvette 221, a reference absorber 222 is provided, which, in this case, comprises a quartz glass cylinder colored with halogenides. The quartz glass cylinder has, basically, a greater long time stability than reference media pumped via a supply line into a cuvette. As a result, the quartz glass cylinder serves especially as reference for validation of the reference media.

FIG. 3 shows absorption spectra in the wavelength range between 200 and 400 nm for a solution of potassium hydrogen phthalate (PHP) in water with a PHP-concentration of 55 mg/l, for a reference absorber of Suprasil-quartz glass, as well as for two reference absorbers of UBK-7-glass of different thicknesses passed through by the measuring radiation, wherein, in the case of the first UBK-7-reference absorber, the measuring radiation passes through a thickness of 2.0 mm, and in the case of the second UBK-7-reference absorber a thickness of 4.5 mm.

PHP-solutions are frequently used as reference liquids for test and for calibrating, or adjusting, of spectrometric measuring devices for determining COD.

As can be seen in FIG. 3, the absorption spectrum of the first UBK-7-reference absorber resembles, in the wavelength range between 200 and 300 nm, very strongly the absorption spectrum of the PHP-solution. Reference absorbers of this glass are, therefore, well suited for calibrating, or adjusting, in the case of COD-measurements, since, with them, PHP-absorption spectra can be simulated. For determining the COD-value, the absorption spectrum of a measured medium is integrated over a predetermined wavelength range and from the integral on the basis of an assignment rule, especially a calibration function, the COD-value of the measured medium is ascertained. The calibration function is ascertained by reference measurements on measured media of known COD-value.

The absorption spectrum of the PHP-solution has in the wavelength range between about 230 nm and 250 nm a negative deviation compared with the absorption spectrum of the first reference absorber of UBK-7-glass. In the wavelength range between 250 nm and about 290 nm, the absorption spectrum of the PHP-solution has, in contrast, a positive deviation compared with the absorption spectrum of the first reference absorber. For this reason, one obtains in the case of the integration of both absorption spectra in the wavelength range between 230 and 290 nm almost equal integral values. The reference absorber of UBK-7-glass of thickness 2.0 mm can thus be used as a solid reference absorber in place of a PHP-solution of concentration 55 mg/l. A PHP-solution of higher concentration can be simulated by the second UBK-7-reference absorber of thickness 4.5 mm. By corresponding selection of the thickness passed through by the measuring radiation and/or the curvature of the surfaces of the reference absorbers, a plurality of PHP-concentrations can be simulated.

As likewise can be seen from FIG. 3, the absorption of Suprasil-quartz glass in the wavelength range between 200 and 400 nm is essentially wavelength independent. A special advantage of Suprasil-quartz glass is that its absorption remains stable over a long period of time also under UV-irradiation.

For internal calibrating of the apparatus, in regular time intervals, for example, three reference absorbers can be introduced one after the other into the measuring beam path, and, in each case, a reference measurement performed. FIG. 4 shows, as an example, a diagram, in which, for a reference absorber of Suprasil-quartz glass, each absorption A₁, A₂, A₃ of the three reference absorbers determined by the reference measurements at a predetermined wavelength is plotted as a function of time. The reference absorbers are so embodied, that they simulate different predetermined reference concentrations or COD values.

As can be seen in the diagram of FIG. 4, the absorption values A₁, A₂, A₃ remain, over a certain period of time, essentially constant. After a while, however, a continuous increase of the absorption values begins. This absorption increase is caused by aging phenomena or by application related conditions, such as, for example, fouling, scratching or clouding of the window sections through which the measurement beam passes due to mechanical loading or aging of the light source or the receiver.

If the absorption values lie within a tolerance interval, which, in each case, is predetermined by the over-under, interval boundaries Tₒ₁ and Tᵤ₁, Tₒ₂ and Tᵤ₂, as well as Tₒ₃ and Tᵤ₃, no compensation is yet needed. If, however, the absorption values exceed the interval boundaries, such as in the illustrated example, in each case, the over, interval boundaries Tₒ₁, Tₒ₂ and Tₒ₃, then, on the basis of a calibration between the predetermined, set absorption values of the reference absorbers and the actual values ascertained by the reference measurements, three correction values Δ₁, Δ₂, Δ₃ are ascertained. From these, a compensation value is ascertained, which is subtracted in the following media measurement from each measured absorption, in order to compensate the apparatus aging effects in the measured value determination.

With further aging, the correction values Δ₁, Δ₂, Δ₃, as a rule, increase further. If the correction values Δ₁, Δ₂, Δ₃, or the therefrom derived compensation values, in each case, exceed a predetermined threshold value, a warning signal can be output. The warning signal signals that, soon, a maintenance measure must be performed, for example, a cleaning of the apparatus or a replacement of the window sections through which the measurement beam passes. Along with the warning signal, a time allowance can be output, which indicates, up to which point in time the measured values can still be reliably ascertained. This is advantageous, since, in this way, maintenance measures can be planned long- or middle-term. The time allowance can be ascertained by extrapolation of the curve of the correction values ΔA₁, Δ₂, Δ₃ or the therefrom derived compensation values. Instead of a warning signal, the control system of the apparatus can also initiate an automatic maintenance routine, for example, for cleaning the piston.

Instead of absorption at a predetermined wavelength, also an integral, or an average value, of the absorption spectrum over a predetermined wavelength range can be used for determining correction values. Equally, the intensity registered by the receiver for reference measurements at a predetermined wavelength, as well as an integral, or an average value, of the intensity, can be used for determining correction values. Likewise, also, from the absorption, or intensity, values of the reference spectra, in each case, a corresponding concentration of a reference substance, e.g. PHP, can be ascertained and therefrom correction values derived. The ordinate value of the graph in FIG. 4 can also be given as a percent referenced to the measuring range and correction values correspondingly ascertained therefrom, on the basis of which, apparatus aging effects in the measured value determination can be compensated.

The different embodiments of the reference body, or reference absorber, are, of course, combinable with one another to the extent desired.

1-20. (canceled)

21. A method for determining a property of a medium, comprising the steps of:
irradiating a space with light along a measuring path between a light source and a light receiver, wherein the light enters into a space through a first window section and leaves the space through a second window section;
registering the intensity of the light, after it has left the space, by means of the receiver and ascertaining absorption along the measuring path, wherein the space between the first window section and the second window section contains, in a media measurement, a medium to be measured, through which the light passes, and wherein, in at least a first reference measurement, a first reference absorber, which has a defined absorption and through which the light passes, is arranged in the space between the first window section and the second window section; and
determining properties of the measured medium on the basis of the absorption during the media measurement, taking into consideration the absorption during the at least one reference measurement.

22. The method as claimed in claim 21, wherein:
at least a second reference measurement occurs, in the case of which a second reference absorber of defined absorption is arranged in the space between the first window section and the second window section.

23. The method as claimed in claim 22, wherein the absorption during the second reference measurement differs from the absorption during the first reference measurement.

24. The method as claimed in claim 21, wherein:
the one or more reference absorbers are integrated in a piston or piston valve, with which the measured medium is sucked into a measuring cylinder, which forms the space, through which the light passes along the measuring path.

25. The method as claimed in claim 21, wherein:
as reference absorber, solid bodies, especially glasses of high purity, are used; and
these solid bodies preferably have an absorption, which remains constant over a plurality of reference measurements.

26. The method as claimed in claim 21, wherein:
on the basis of the reference measurements, compensation values are calculated and stored.

27. The method as claimed in claim 21, wherein:
data of the reference measurements, especially compensation values, are registered long term and statistically evaluated, for example, in order to establish maintenance points in time and/or to identify, in the case of reference measurements, changes in the measuring path.

28. The method as claimed in claim 27, wherein:
on the basis of the statistical evaluation, a warning signal is generated, which displays, that a maintenance measure is to be performed.

29. The apparatus for determining a property of a medium, comprising:
a housing;
a light source in said housing, for irradiating a space along a measuring path;
a receiver in said housing, for registering intensity of light that has traversed the measuring path; and
at least one reference absorber, which is introducible at times into the space, wherein the measuring path for at least one reference measurement extends through the reference absorber, when the reference absorber has been introduced into the space, wherein:
the measuring path enters into the space through a first window section in a wall of said housing of the light source; and
the measuring path leaves from the space through a second window section in a wall of said housing of the receiver; and
a medium to be measured is introducible in such a manner into the space, that the measuring path for a media measurement extends through the measured medium.

30. The apparatus as claimed in claim 29, further comprising:
at least a second and, in given cases, other reference absorbers.

31. The apparatus as claimed in claim 29, wherein:
said at least one reference absorber has a solid body with a definedly coated surface, for example, with constant layer thickness, or layer density, or with a layer thickness or layer density variable in a coordinate of the reference absorber.

32. The apparatus as claimed in claim 29, wherein:
said at least one reference absorber comprises a solid body, which is colored within its volume, for example, a colored glass body.

33. The apparatus as claimed in claim 29, wherein:
said at least one reference absorber comprises scattering media, especially suspensions, or solid diffusion disks, which lessen measured intensity by light scattering.

34. The apparatus as claimed in claim 29, wherein:
said at least one reference absorber comprises an essentially transparent matrix, in which absorbing, or scattering, particles are embedded.

35. The apparatus as claimed in claim 29, wherein:
said at least one reference absorber comprises a transparent container, which contains a reference medium with defined absorption, for example, a reference liquid.

36. The apparatus as claimed in claim 35, wherein:
said container can be filled and emptied via lines, in order, in given cases, to be able to introduce different reference liquids with different defined absorption characteristics into the container.

37. The apparatus as claimed in claim 29, wherein:
said at least one reference absorber is integrated in a piston or piston valve, with which the measured medium is sucked into a measuring cylinder, which forms the space, through which light passes along the measuring path.

38. The apparatus as claimed in claim 37, wherein:
said piston comprises sealing elements, with sealing lips serving as wipers, whereby the piston or piston valve in a stroke movement cleans the window sections in the measuring path.

39. The apparatus as claimed in claim 37, wherein:
said measuring cylinder contains a cleaning section with an inlet opening and an outlet opening in a lateral surface; and
the piston has an upper seal and a lower seal, whose separation has a larger axial extent than the axial distance between the inlet opening and the outlet opening.

40. The apparatus as claimed in claim 29, wherein:
said at least one reference absorber is hydraulically or pneumatically movable by means of a drive, for example, a stepper motor.
